(19) United States
(12) Patent Application Publication
(10) Pub. No.: US 2005/0233089 A1
(43) Pub. Date: Oct. 20, 2005

(54) Sputter method or device for the production of natural voltage optimized coatings

(76) Inventor: Walter Haag, Grabs (CH)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/515,792

(22) PCT Filed: Apr. 30, 2003
(86) PCT No.: PCT/EP03/04572

§ 371 Date: Jun. 27, 2005

(30) Foreign Application Priority Data
May 22, 2002 (DE) 102 22 909.0

(51) Int. Cl. B05D 1/04

(52) U.S. Cl. 427/458

(57) ABSTRACT

The invention relates to a method or a device for the production of especially natural voltage optimized coatings, especially low tensile stress coatings, by means of sputter processes, wherein a bipolar voltage shape is produced on the target (cathode). The positive voltage pulse is adjusted on the target in such a way that a bias voltage on the substrate is thus replaced.

This invention relates to a method and a device for sputter coating processes, with which, in particular, residual-stress-optimized coatings can be produced.

The prior art contains descriptions of how to produce coatings on substrates by means of sputter processes in which a plasma is ignited in a vacuum system, the ions in the plasma being accelerated onto the target—which contains the coating material—by application of a suitable potential difference and said ions removing material from said target so that the material can be deposited on the substrate to be coated. The potential difference that must be applied to the target can be generated either by applying a direct voltage or a pulsed voltage. For pulsed operation, frequencies extending right up into the high-frequency range (radio frequency RF) can be selected. However, if possible, the target or sputter cathode is normally always kept at a negative potential, or, in the case of bipolar, pulsed operation, at only a very low positive potential when in the positive pulse range, because a positive pulse is disadvantageous due to its withdrawing charge carriers (electrons) from the plasma. In certain cases, though, this is necessary to the small extent indicated above, if, for example during the sputtering of dielectric materials, an insulating layer forms on the target and impairs the capacitive characteristics of the coating device. In such cases it may be necessary to allow the voltage curve to swing further into the positive potential range, or to apply a low positive voltage, in order to effect a target discharge and thus oppose the charge build-up on the insulating layers. However, on account of the above-described counterproductive effect of a positive potential on the sputter cathode or target, the positive potential is, according to the prior art, kept very low or avoided if possible.

For the production of coatings that are as devoid as possible of residual stresses, the prior art also describes the application of a bias voltage to the substrate during the coating process. This bias voltage can likewise be unipolar or a bipolar, pulsed voltage. Application of a bias voltage to the substrate causes the coating being built up on the substrate to be bombarded with ions, or, in the case of bipolar operation, with ions and electrons. This bombardment of the substrate with ions or with ions and electrons, which are accelerated by the bias voltage on the substrate, reduces any residual stress that may be building up during deposition of the coating by way of selectively influencing the film microstructure. The disadvantage of this approach, however, is that the substrate is subjected to higher temperatures as a result of being bombarded with ions or with ions and electrons. The coating process is also more complicated, since a voltage source is required for the substrate. If pulsed operation is used for the bias voltage, additional systems are needed, for example signal generators, filters or synchronization components in the case of a pulsed bias voltage operated synchronously with the cathode voltage. A further disadvantage is that sputter processes involving a substrate bias voltage are more difficult to handle since, for instance, the bias voltage can change during the process due to thermal effects; it is also possible that flashovers, for example, will occur at the substrate as a result of the bias voltage.

The object of this invention is therefore to provide a method and a device for the coating of substrates by means of sputter processes, with which the disadvantages described above can be reduced or avoided. A particular aim is to permit the creation of film properties and residual-stress-optimized films on substrates for which the application of a bias voltage is only possible under difficult conditions or not at all, as is the case, for example, with substrates in rotating substrate baskets or other carriers. As far as stress optimization of the films is concerned, the aim is to largely reduce or to prevent the particularly disadvantageous residual tensile stresses in the films, or to reverse them into compressive stresses. In addition, the method and the device are intended to be of simple design and easy, i.e. economical, to operate.

This objective is established by a method having the features of claim 1, and by a device having the features of claim 6. Useful embodiments of the invention constitute the subject matter of the dependent claims.

The especially simple solution to the problem outlined above consists chiefly in dispensing entirely with the substrate bias voltage that is associated with the above-described disadvantages and, instead, adjusting a positive target voltage pulse—on the basis of earlier findings considered in the prior art as being disadvantageous—in such a manner that the substrate bias voltage can be replaced therewith. If the positive potential pulse applied to the target is suitably adjusted, ions can be accelerated onto the substrate—for example, positively charged argon ions if argon is used as insert gas. The effect is the same as that obtained by applying a substrate bias voltage, in which case, likewise as a result of ions being accelerated from the plasma onto the substrate—the film microstructuree is influenced in such a way that negative tensile residual stresses are reduced. An additional advantage of the method of the invention is that sputter reflow effects are also achieved. If the positive acceleration voltage for the ions is raised beyond a sputter threshold, atoms that were initially only loosely bound in the coating film can be made to flow back out of the film; this is important for sidewall coverage in the coating of high aspect ratio structures.

Contrary to a substrate bias voltage, the application of a pulsed positive voltage to the target results only in a pulsed bombardment of the substrate with ions, and not a continuous bombardment with ions or with ions and electrons. In this way, the thermal stress on the substrate is minimized. In addition, it is possible to selectively influence the film microstructure also in the case of substrates to which it is difficult or even impossible to apply a bias voltage. Another advantage of replacing the substrate bias voltage by positive voltage pulses applied to the target is that the cost of equipping and operating the coating device is reduced, since no additional voltage source need be provided for a bias voltage on the substrate.

It is useful in this context to generate both the negative basic signal shape for the voltage signal at the sputter cathode (target) and also the positive voltage signal for the method of the invention by means of a signal generator at the target. The arrangement simplifies the sputter-coating device and makes its operation less complicated.

However, so that the frequency, signal shape, amplitude, etc. of the pulsed positive voltage signal at the target can be adjusted as freely as possible, it is preferable to generate the voltage signal at the sputter cathode (target) by way of superposing a negative basic signal shape with a pulsed positive voltage signal.

In the production of a variety of films by the method of the invention it has been found especially beneficial to select the amplitude of the positive voltage pulse in the range from 30 to 2,000 V, especially 40 to 1,800 V, preferably 50 to 1,000 V, and/or to select the pulse duration of the positive voltage pulse in the range from 1 to 20 μs. Itr has also been found useful to select a frequency in the range from 15 to 450 kHz.

Further advantages, characteristics and features of this invention become clear in the following detailed description of a comparative example and from the enclosed drawings.

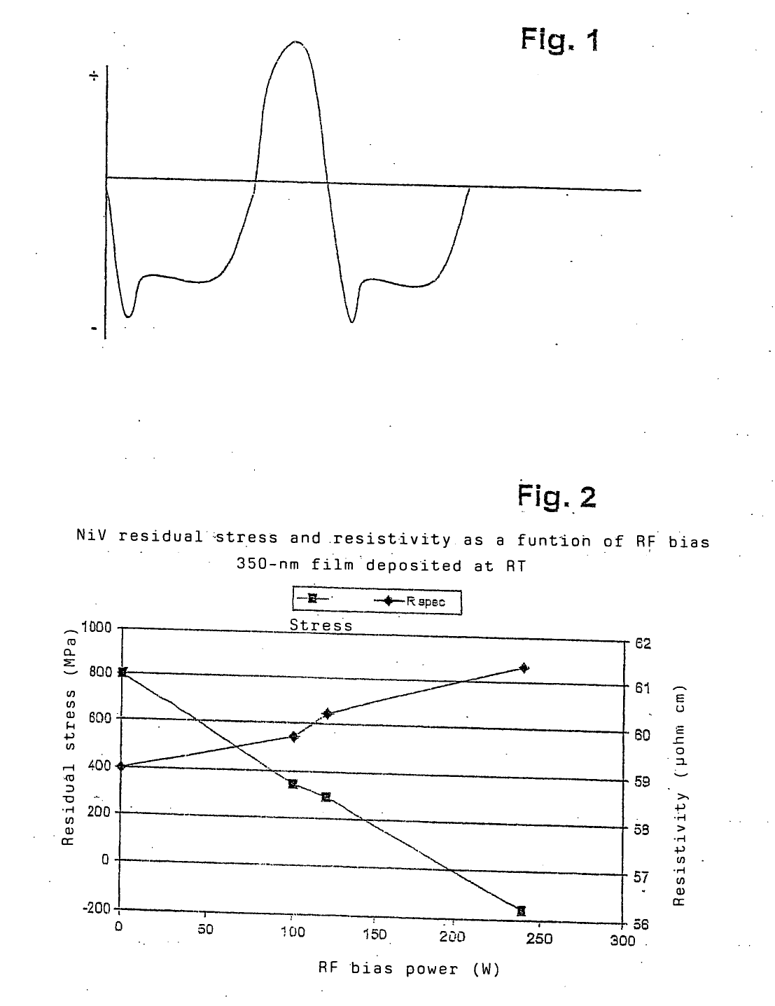

FIG. 1 shows a typical target potential profile;

FIG. 2 shows the reduction in residual stress and the increase in resistivity in films deposited with a high-frequency bias voltage;

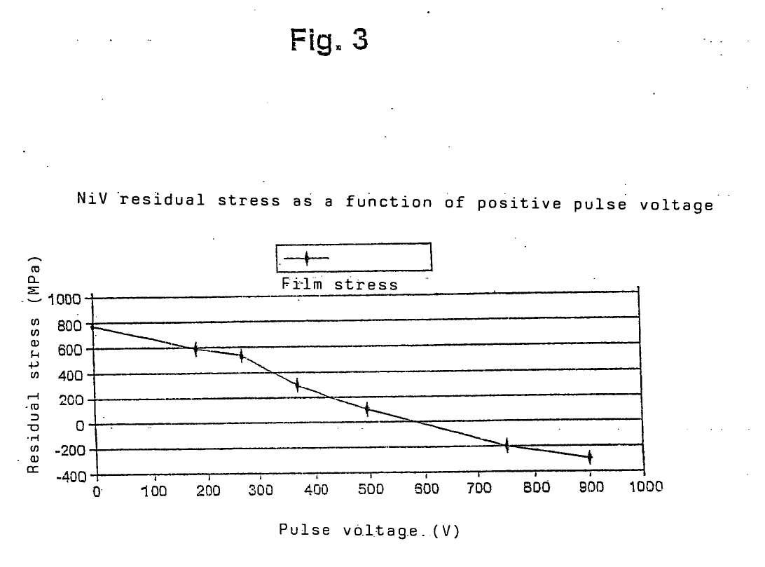

FIG. 3 shows the reduction or reversal of residual stresses in films deposited with the method of the invention.

In this comparative example, the influence on residual stresses in NiV films obtained by applying an RF bias voltage to the substrate during deposition is compared with the residual stress development in NiV films that were deposited with different positive voltage pulses according to the method of the invention. FIG. 1 shows the typical signal shape used in the method of the invention. Besides a half-wave with negative potential, each cycle includes a half-wave with positive target potential.

On comparison of the residual stresses within the NiV films deposited on the one hand by a method according to the prior art (FIG. 2) and on the other hand by the method of the invention (FIG. 3), it becomes clear that the same effects can be obtained with the method of the invention as with a substrate bias voltage.

The NiV films, the residual stresses of which are plotted against RF bias power in FIG. 2, were deposited on a heated substrate to which a bipolar, pulsed RF bias voltage was applied. By means of a routine DC sputtering process with a sputtering power of 9 kW and an argon flow rate of about 48 sccm, NiV films with a film thickness of about 3500 Å were deposited at a sputtering rate of about 15.6 Å/s per kW power. As is seen in FIG. 2, the residual stress in the NiV films decreases with increasing RF bias power until there is even a residual stress reversal from tensile to slightly compressive.

This positive effect was likewise generated in the NiV films produced by the method of the invention, not by using a bias voltage but, as is provided for by the invention, by applying bipolar pulses to the target (cf. FIG. 1). The other parameters remained unchanged. As is seen in FIG. 3, the residual tensile stresses in the NiV films decrease, or even reverse to become compressive, as the positive potential of the positive voltage pulse increases. By contrast, in NiV films deposited without a positive pulse portion, no significant changes in the residual stress were registered, not even by varying the negative pulse voltages from −900 V to approx. −1,600 V.

1-7. (canceled)

8. A method of producing residual-stress-optimized coatings by means of sputter processes comprising:
generating a bipolar, pulsed voltage characteristic at a target; and
adjusting a positive voltage pulse applied to the target in such a way that ions are accelerated onto the target and a bias voltage on the target is thus replaced.

9. The method of claim 8, wherein the positive voltage pulse is generated by superposing a negative basic signal shape with a pulsed positive voltage signal, and wherein signal characteristics of the pulsed positive voltage signal are adjustable.

10. The method of claim 8, wherein the positive voltage pulse has an amplitude of to 2,000 V.

11. The method of claim 10, wherein the positive voltage pulse has an amplitude of to 1,800 V.

12. The method of claim 11, wherein the positive voltage pulse has an amplitude of 50 to 1,000 V.

13. The method of claim 8, wherein the positive voltage pulse has a pulse duration of 1 to 20 μs.

14. The method of claim 8, wherein the positive voltage pulse is applied with a frequency of 15 to 450 kHz.

15. The method of claim 8, wherein the coatings are low-tensile stress coatings.

16. A sputter coating device for the production of coatings comprising:
a voltage supply device with which a pulsed, positive voltage signal at a target can be adjusted and which is sufficiently powerful to accelerate ions onto the target and thus replace a bias voltage on the target.

17. The sputter coating device of claim 16, further including a signal generator for generation of voltage on the target, wherein the signal generator generates both a negative basic signal shape as well as a positive voltage signal.

18. The sputter coating device of claim 16, wherein the coatings are residual-stress-optimized coatings.

19. A sputter coating device for the production of coatings according to the method of claim 8.
